(19) United States
(12) Patent Application Publication
(10) Pub. No.: US 2015/0343827 A1
(43) Pub. Date: Dec. 3, 2015

(54) PRINTING DEVICE, BOOKBINDING DEVICE, AND PRINTING/BOOKBINDING SYSTEM

(71) Applicant: Mitsubishi Heavy Industries Printing & Packaging Machinery, Ltd., Mihara-shi, Hiroshima (JP)

(72) Inventors: Isami MITAMURA, Mihara-shi, Hiroshima (JP); Makoto KAJI, Mihara-shi, Hiroshima (JP); Koji NISHIYAMA, Mihara-shi, Hiroshima (JP); Norifumi TASAKA, Mihara-shi, Hiroshima (JP)

(21) Appl. No.: 14/759,931

(22) PCT Filed: Nov. 15, 2013
(86) PCT No.: PCT/JP2013/080950

§ 371 Date: Jul. 9, 2015

(30) Foreign Application Priority Data
Jan. 30, 2013 (JP) 2013-016113

(51) Int. Cl. B42C 19/04; B65H 35/00; B65H 45/22; B41L 43/02

(52) U.S. Cl. CPC B42C 19/04; B41L 43/02; B65H 35/008; B65H 45/22

(57) ABSTRACT

The present invention makes it possible to continuously print and bind different kinds of printed matter by providing the printing device, bookbinding device and printing/bookbinding system with: a paper-supplying unit for supplying a web from rolled paper; a printer capable of printing different images continuously on the web; a folding machine for forming signatures by longitudinally cutting and stacking the printed web and then folding longitudinally and cutting transversely; a conveyance unit having multiple conveyance lines for stacking and conveying only specified numbers of signatures; a distributing unit for distributing the signatures to one of the multiple conveyance lines; and a print control unit for making it possible to continuously discharge differing numbers of signature bundles from the multiple conveyance lines by operating the distributing unit according to a print command.

### TECHNICAL FIELD

The present invention relates to a printing device which makes it possible to continuously print different types of printed matter, a bookbinding device which makes it possible to continuously bind different types of printed matter printed by using the printing device, and a printing/bookbinding system having the printing device and the bookbinding device.

### BACKGROUND ART

In general, as a printer which prints printed matter, there is a rotary press using a plate or a digital printer using an ink jet head or the like. The rotary press performs printing by using a plate, and therefore, the rotary press is effective in a case of printing a large amount of printed matter such as a newspaper. On the other hand, the digital printer performs printing by using digital data, and therefore, it is possible to deal with printing regardless of the number of copies of printed matter.

As such a printer, for example, there are devices disclosed in PTLs 1 and 2 below. A folding machine with a signature discharge number change-over device disclosed in PTL 1 is for shaping signatures by a plurality of triangular plates disposed in upper and lower stages and a cutting unit, alternately distributing the signatures to a paper discharge unit on one side and a paper discharge unit on the other side having a reversing cylinder by a distributing unit, and stacking and discharging bundles of the signatures coming out from both paper discharge units. Further, a newspaper producing method disclosed in PTL 2 is for printing a horizontal print row having at least two printed surfaces corresponding to each other in a width direction, on both surfaces of a continuous sheet of paper repeatedly in a printing direction by using a digital printer, with a plurality of horizontal print rows having different print contents for each horizontal print row as one printing cycle, cutting the sheet every two-page spread in each horizontal print row, making a set for each printing cycle, and applying a fold line in the form of a spread.

### CITATION LIST

### Patent Literature

[PTL 1] Japanese Unexamined Patent Application Publication No. 09-058916

[PTL 2] Japanese Patent No. 4022901

### SUMMARY OF INVENTION

### Technical Problem

Incidentally, the above-described rotary press is effective in a case of printing a large amount of printed matter. However, a manufacturing cost increases in a case of printing a small amount of printed matter, printed matter of a page unit rather than a plate unit, or multi-page printed matter. Further, in a digital printer, although it is possible to perform printing without being limited to the number of copies or the number of pages of printed matter, it is difficult to bind multi-page printed matter as signatures online and at a high speed by continuously performing a plurality of jobs.

The present invention is for solving the above-described problems and has an object to provide a printing device which makes it possible to continuously print different types of printed matter, a bookbinding device which makes it possible to continuously bind different types of printed matter, and a printing/bookbinding system which makes it possible to continuously print and bind different types of printed matter.

### Solution to Problem

In order to achieve the above object, according to an aspect of the present invention, there is provided a printing device including: a paper-supplying unit that supplies a web from rolled paper; a digital printer capable of continuously printing different images on the web sent out from the paper-supplying unit; a folding machine that forms signatures by stacking, folding, and then transversely cutting the webs printed by the digital printer; a conveyance unit having a plurality conveyance lines for conveying the signatures formed by the folding machine with the signatures stacked by a predetermined number; a distributing unit that distributes the signatures formed by the folding machine to any one of the plurality of conveyance lines; and a print controller that allows different numbers of signatures to be continuously discharged from the plurality of conveyance lines by distributing the signatures formed by the folding machine according to print information of printed matter that is printed to the plurality of conveyance lines by controlling an operation of the distributing unit.

Therefore, the print controller operates the distributing unit according to print information, and therefore, the signatures formed in the folding unit are distributed to the plurality of conveyance lines by a necessary number, and thus it is possible to continuously discharge a different number of signatures from each conveyance line without stopping the device, whereby it is possible to improve the productivity of a printing job.

In the printing device according to the above aspect of the present invention, the plurality of conveyance lines has a first conveyance line and a second conveyance line, and the print controller counts the signatures formed by transversely cutting the webs in the folding machine and switches an output destination of the folding machine between the first conveyance line and the second conveyance line by the distributing unit if the number of counts of the signatures reaches a predetermined number of counts set in advance.

Therefore, the distributing unit switches an output destination between the first conveyance line and the second conveyance line if the number of signatures formed in the folding machine reaches the number set in advance, and therefore, it is possible to continuously perform a printing job without stopping the paper-supplying unit, the digital printer, and the folding unit.

In the printing device according to the above aspect of the present invention, during the signatures formed in the folding machine are stacked on the first conveyance line, the signatures stacked on the second conveyance line by a predetermined number are discharged.

Therefore, while the signatures are stacked on the first conveyance line, the second conveyance line discharges a predetermined number of signatures, and therefore, signature stacking work and signature discharge work are alternately performed in the respective conveyance lines, whereby it is possible to continuously perform a printing job without stopping various units.

In the printing device according to the above aspect of the present invention, the folding machine has a cutting unit that transversely cuts the longitudinally slit and stacked webs, and the print controller makes it possible to change a cutting timing by the cutting unit according to a print command.

Therefore, a timing of cutting the webs is changed according to a print command, whereby it is possible to form the signatures having different lengths without stopping a printing job.

In the printing device according to the above aspect of the present invention, the conveyance unit has a stacking unit that stacks a plurality of signatures discharged from the plurality of conveyance lines.

Therefore, the plurality of signatures which are discharged in the plurality of conveyance lines are stacked by the stacking unit, whereby it is possible to efficiently form signatures having a large number of pages.

In the printing device according to the above aspect of the present invention, the digital printer has one or more ink jet printers.

Therefore, the digital printer adopts an ink jet printer, whereby it is possible to enable simplification and cost reduction of the device.

In the printing device according to the above aspect of the present invention, the print controller can output timing data or informations in which the type of the signature is changed, to a bookbinding device.

Therefore, the timing data in which the type of the signature is changed is output from the printing device to the bookbinding device, whereby printed matter which is formed from the signatures can be continuously treated in the bookbinding device.

Further, according to another aspect of the present invention, there is provided a bookbinding device including: a milling unit that cuts off a back side in printed matter by a predetermined amount and then applies glue; a front cover attaching unit that bonds a front cover to the outside of the printed matter; a drying unit that circulates the printed matter, thereby drying the glue; a cutting unit that cuts an outer peripheral side of the printed matter; and a bookbinding controller that changes specifications in the milling unit, the front cover attaching unit, the drying unit, and the cutting unit according to timing data in which the type of the printed matter is changed, having output from a printing device.

Therefore, the specifications of various units are changed according to the timing data in which the type of the printed matter is changed, and therefore, it is possible to continuously bind printed matter having different numbers of signatures without stopping the device, whereby it is possible to improve the productivity of a printing job.

Further, according to another aspect of the present invention, there is provided a printing/bookbinding system including: a printing device that can continuously print different images on a web by a digital printer, form signatures by longitudinally slitting and stacking printed webs and then longitudinally folding and transversely cutting the webs, and distribute the signatures to a plurality of conveyance lines, thereby discharging printed matter having a different number of signatures for each of the conveyance lines; a bookbinding device that cuts off a back side in the printed matter by a predetermined amount and then applies glue, bonds a front cover to the outside of the printed matter, performs drying, and then cuts an outer peripheral side of the printed matter; and a printing/bookbinding controller that changes specifications in the bookbinding device according to print information of the printed matter which is printed in the printing device.

Therefore, the exchange of data relating to the type of the printed matter is performed between the printing device and the bookbinding device, whereby it is possible to continuously print and bind different types of printed matter.

### Advantageous Effects of Invention

According to the printing device, the bookbinding device, and the printing/bookbinding system related to the present invention, in the printing device, it is possible to continuously print different types of printed matter, and in the bookbinding device, it is possible to continuously bind different types of printed matter, and in the printing/bookbinding system, it is possible to continuously print and bind different types of printed matter.

### BRIEF DESCRIPTION OF DRAWINGS

FIG. 1 is a schematic configuration diagram showing a printing device according to an embodiment of the present invention.

FIG. 2 is a schematic diagram showing a web cutting unit.

FIG. 3 is a schematic diagram showing an operation of the web cutting unit.

FIG. 4 is a schematic diagram showing an operation timing of the web cutting unit.

FIG. 5 is a schematic diagram showing an operation timing of the web cutting unit.

FIG. 6 is a schematic diagram showing a web distributing unit.

FIG. 7 is a schematic diagram showing an operation of the web distributing unit.

FIG. 8 is a flowchart showing a printing method using the printing device of this embodiment.

FIG. 9 is a timing chart showing the printing method of this embodiment.

FIG. 10A is a schematic diagram showing an imposition on a web.

FIG. 10B is a schematic diagram showing the longitudinally cut and stacked webs.

FIG. 10C is a schematic diagram showing the longitudinally folded webs.

FIG. 10D is a schematic diagram showing transversely cut signatures.

FIG. 10E is a schematic diagram showing the bound signatures.

FIG. 11 is a schematic configuration diagram showing a printing/bookbinding system.

### DESCRIPTION OF EMBODIMENTS

Hereinafter, preferred embodiments of a printing device, a bookbinding device, and a printing/bookbinding system according to the present invention will be described in detail with reference to the accompanying drawings. In addition, the present invention is not limited by the embodiments.

### Embodiment

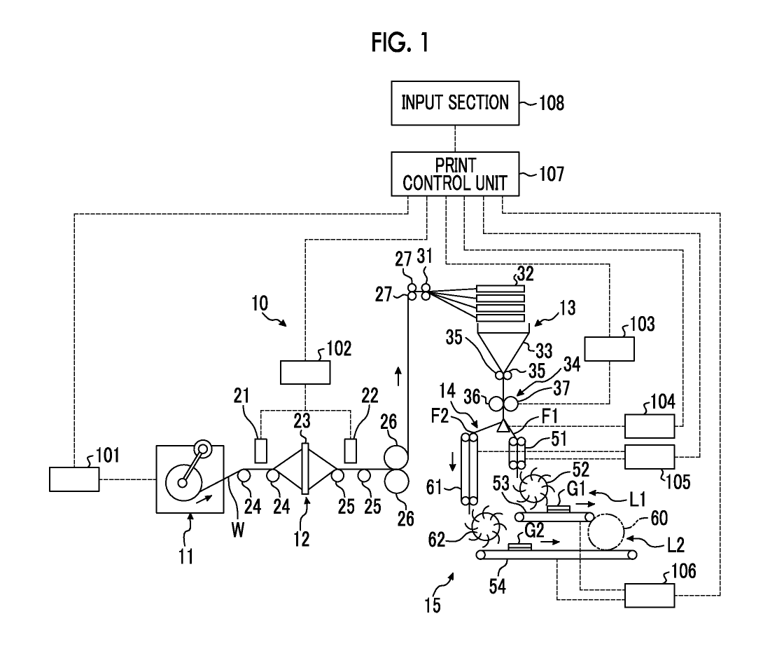

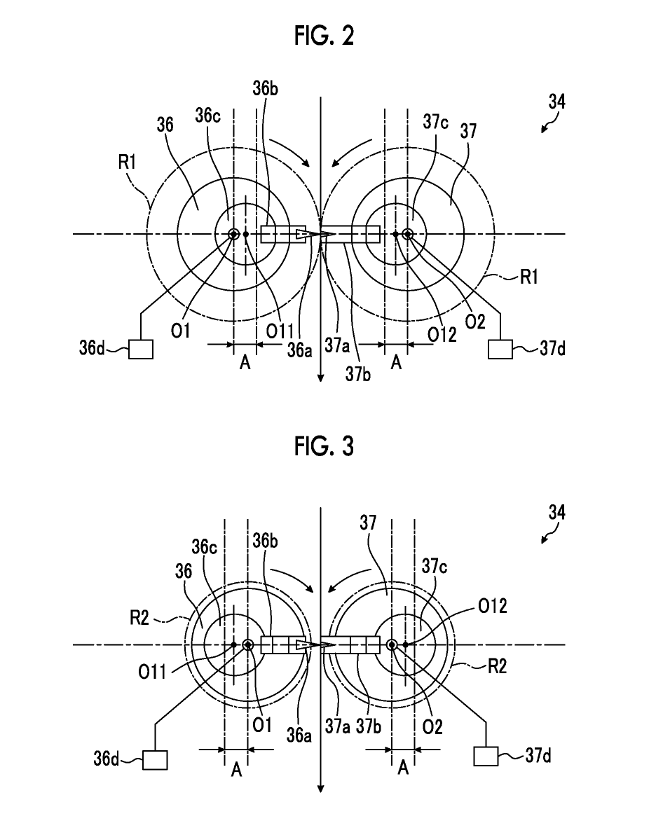

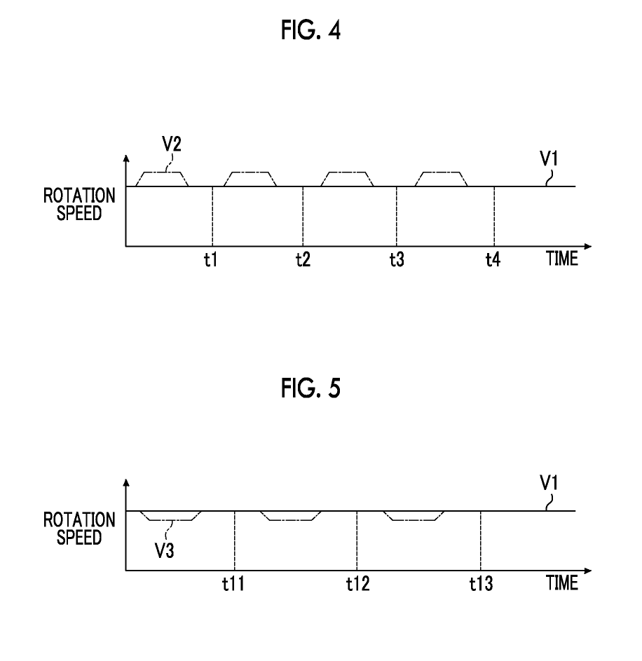

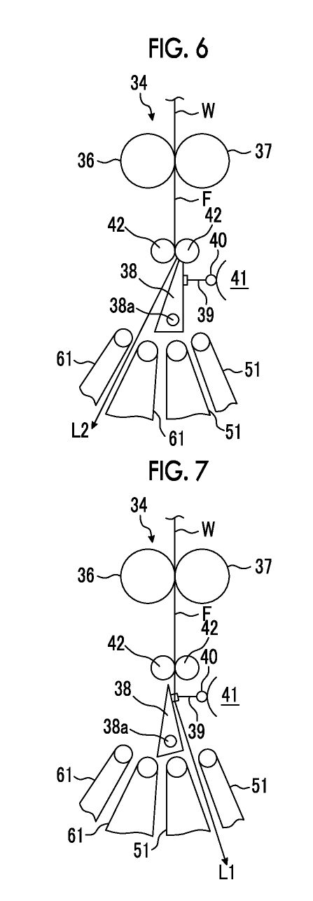

FIG. 1 is a schematic configuration diagram showing a printing device according to an embodiment of the present invention, FIG. 2 is a schematic diagram showing a web cutting unit, FIG. 3 is a schematic diagram showing an operation of the web cutting unit, FIG. 4 is a schematic diagram showing an operation timing of the web cutting unit, FIG. 5 is a schematic diagram showing an operation timing of the web cutting unit, FIG. 6 is a schematic diagram showing a web distributing unit, and FIG. 7 is a schematic diagram showing an operation of the web distributing unit.

A printing device 10 of this embodiment is configured to have a paper-supplying unit 11, a printer 12, a folding machine 13, a distributing unit 14, and a conveyance unit 15, as shown in FIG. 1. In addition, although not shown in the drawing, a drying unit may be provided on the downstream side in a conveyance direction of a web W in the printer 12.

The paper-supplying unit 11 can hold rolled paper with the web W wound in a roll shape and send out the web W at a predetermined speed. The printer 12 has a front face printing unit 21, a rear face printing unit 22, and a reversing unit 23. The front face printing unit 21 is a printing unit which performs a multicolor printing on the front face of the web W supported by a guide roller 24. The rear face printing unit 22 is a printing unit which performs a multicolor printing on the rear face of the web W supported by a guide roller 25. Each of the printing units 21 and 22 is configured with an ink jet printer as a variable printer.

In addition, the ink jet printer is applied as the variable printer. However, it is acceptable if it is a digital printer capable of directly receiving and printing data created in an editing system or the like, and there is no limitation to an ink jet method and it is regardless of a drawing method such as an electrophotographic method.

Since the front face printing unit 21 and the rear face printing unit 22 perform printing by ink jet heads from above the web W which is conveyed, the reversing unit 23 which reverses the front and the back of the web W is disposed between the front face printing unit 21 and the rear face printing unit 22. In addition, the reversing unit 23 may be omitted by disposing the front face printing unit 21 and the rear face printing unit 22 at different upper and lower positions.

The folding machine 13 is for forming signatures F by longitudinally cutting the web W with printing performed on the front face and the rear face by the printer 12 and having been conveyed by guide rollers 26 and 27, into a plurality of webs, stacking the webs, and thereafter, longitudinally folding and then transversely cutting the webs W. The folding machine 13 has a slitter 31, a turn bar 32, a triangular plate 33, and a cutting unit 34.

The slitter 31 is for cutting the web W along a longitudinal direction (a longitudinal direction of the web W, a conveyance direction of the web W), and in this embodiment, the slitter 31 forms four webs W having the same width by cutting the web W along the longitudinal direction at three places in a width direction. The turn bar 32 stacks the four webs W longitudinally cut by the slitter 31 one above the other and sets a conveyance pathway. The triangular plate 33 longitudinally folds the four webs W stacked by the turn bar 32.

The cutting unit 34 forms signatures F (F1 and F2) by transversely cutting the four webs W longitudinally folded by the triangular plate 33 and conveyed by a guide roller 35, into a predetermined length. In the cutting unit 34, a cutting cylinder 36 and a female cutting cylinder 37 are disposed to face each other on the right and left with the web W interposed therebetween.

In the cutting unit 34, as shown in FIG. 2, a cutting blade 36a is supported on a cutting blade holder 36b on the circumferential surface of the cutting cylinder 36. On the other hand, a female cutting rubber holder 37a is provided in the circumferential surface of the female cutting cylinder 37, and the female cutting rubber holder 37a is configured with an elastic body such as rubber and supported on a cutting blade holder 37b. In this case, the cutting cylinder 36 and the female cutting cylinder 37 rotate in synchronization at the same circumferential speed, and thus the rotational phases thereof coincide with each other such that the cutting blade 36a and the female cutting rubber holder 37a face each other at a constant frequency. For this reason, when the cutting cylinder 36 and the female cutting cylinder 37 rotate in synchronization and the cutting blade 36a and the female cutting rubber holder 37a coincide with each other to face each other, the web W is transversely cut by the cutting blade 36a, and thus the signature F having a predetermined length can be formed.

The cutting unit 34 is made so as to be able to change the length of the signature F by changing a timing of cutting the web W. That is, a shaft center O1 and a shaft center O11 are disposed to be shifted with respect to each other by a predetermined distance (A/2), whereby the cutting cylinder 36 and a support shaft 36c are at eccentric positions, and a shaft center O2 and a shaft center O12 are disposed to be shifted with respect to each other by a predetermined distance (A/2), whereby the female cutting cylinder 37 and a support shaft 37c are at eccentric positions. Then, the support shafts 36c and 37c are rotatably supported on a frame, and the cutting cylinder 36 and the female cutting cylinder 37 are respectively fitted onto the outside of the support shafts 36c and 37c, thereby being relatively rotatable, and can be integrally connected at a predetermined rotational position. Then, the support shafts 36c and 37c can be moved in a radial direction by adjustment units 36d and 37d, that is, the cutting cylinder 36 and the female cutting cylinder 37 can come close to each other and be separated from each other.

Therefore, in a state shown in FIG. 2, the cutting cylinder 36 and the female cutting cylinder 37 are at the most separated positions and loci of rotation (circumferences) R1 of the cutting blade 36a and the female cutting rubber holder 37a become the longest, and therefore, it is possible to make the length of the signature F the longest. Then, the connection of the cutting cylinder 36 and the female cutting cylinder 37 to the support shafts 36c and 37c is released by the adjustment units 36d and 37d, each of the support shaft 36c and the cutting cylinder 36 and each of the support shaft 37c and the female cutting cylinder 37 are relatively rotated by 180 degrees, as shown in FIG. 3, and thereafter, the cutting cylinder 36 (the support shaft 36c) and the female cutting cylinder 37 (the support shaft 37c) are moved by a predetermined distance A, thereby being brought close to each other. Then, a state shown in FIG. 3 is created, and thus the cutting cylinder 36 and the female cutting cylinder 37 are at the closest positions and the loci of rotation (circumferences) R2 of the cutting blade 36a and the female cutting rubber holder 37a become the shortest, and therefore, it is possible to make the length of the signature F the shortest.

Further, a configuration of making it possible to change the length of the signature F by changing a timing of cutting the web W is not limited to the configuration described above. For example, as shown in FIG. 4, when a conveyance speed V1 of the web W is constant, the rotation speeds of the cutting cylinder 36 and the female cutting cylinder 37 are increased to V2 at rotational positions other than rotational positions t1, t2, t3, t4, . . . at which the web W is cut by the cutting blade 36a and the female cutting rubber holder 37a. Then, the length of the signature F which is cut by the cutting blade 36a and the female cutting rubber holder 37a becomes shorter. On the other hand, as shown in FIG. 5, when the conveyance speed V1 of the web W is constant, the rotation speeds of the cutting cylinder 36 and the female cutting cylinder 37 are reduced to V3 at rotational positions other than rotational positions t11, t12, t13, . . . at which the web W is cut by the cutting blade 36a and the female cutting rubber holder 37a. Then, the length of the signature F which is cut by the cutting blade 36a and the female cutting rubber holder 37a becomes longer.

In addition, in this embodiment, the cutting blade 36a and the female cutting rubber holder 37a are provided in a set at outer peripheral portions of the cutting cylinder 36 and the female cutting cylinder 37. However, there is no limitation to the number and two or more sets may be provided according to the diameters of the cutting cylinder 36 and the female cutting cylinder 37.

In the distributing unit 14, as shown in FIG. 6, a distributing guide 38 has a triangular shape and is rotatably supported by a support shaft 38a. Then, a roller 40 connected to the distributing guide 38 by a connecting link 39 is in contact with the circumferential surface of a cam roller 41. For this reason, the roller 40 moves along the circumferential surface according to the rotation of the cam roller 41, thereby being able to move the distributing guide 38 through the connecting link 39. That is, if the distributing guide 38 is moved to a position shown in FIG. 6, the signature F formed by transversely cutting the web W by the cutting unit 34 is guided by a guide roller 42 and can be then distributed to a conveyance line L2 by the distributing guide 38. On the other hand, if the distributing guide 38 is moved to a position shown in FIG. 7, the signature F formed by transversely cutting the web W by the cutting unit 34 is guided by the guide roller 42 and can be then distributed to a conveyance line L1 by the distributing guide 38.

The conveyance unit 15 has a plurality of (in this embodiment, two) conveyance lines L1 and L2 and conveys the signatures F (F1 and F2) distributed by the distributing unit 14, as signature bundles G (G1 and G2) with the signatures F (F1 and F2) stacked by a predetermined number, thereby discharging the signatures F (F1 and F2) by the predetermined number. The conveyance lines L1 and L2 have a pair of conveyance belts 51 and 61, delivery fans 52 and 62, and upper and lower conveyors 53 and 54. In addition, with respect to the predetermined number of the signatures F (F1 and F2) which are distributed by the distributing unit 14, there is a case where the predetermined number is the same in the conveyance lines L1 and L2 and there is also a case where the predetermined number is different in the conveyance lines L1 and L2.

The conveyance belts 51 and 61 convey the signatures F (F1 and F2) with the signatures sandwiched therebetween. The delivery fans 52 and 62 rotate with a predetermined rotation, thereby stacking the signatures F (F1 and F2) received from the conveyance belts 51 and 61 on the upper stage conveyor 53 and the lower stage conveyor 54. The upper and lower conveyors 53 and 54 make the signatures F (F1 and F2) received from the delivery fans 52 and 62 be aligned and stacked thereon and discharge the signature bundles G (G1 and G2) with a predetermined number of signatures F (F1 and F2) stacked, to the outside.

In addition, the conveyance unit 15 can be provided with a stacking cylinder (a stacking unit) 60 at terminus portions of the upper and lower conveyors 53 and 54. The stacking cylinder 60 superimposes the signature bundle G1 stacked on the upper stage conveyor 53 on the signature bundle G2 stacked on the lower stage conveyor 54, and thus the lower stage conveyor 54 discharges the signature bundles G1 and G2 as the signature bundle G (G1+G2).

The printing device 10 of this embodiment configured in this manner is provided with a paper-supplying control unit 101 which controls the driving of the paper-supplying unit 11, a printer control unit 102 which controls the driving of the printer 12, a folding machine control unit 103 which controls the driving of the folding machine 13, a distribution control unit 104 which controls the driving of the distributing unit 14, a first conveyance control unit 105 which controls the driving of the conveyance belts 51 and 61 and the delivery fans 52 and 62 in the conveyance unit 15, a second conveyance control unit 106 which controls the driving of the upper stage conveyor 53 and the lower stage conveyor 54 in the conveyance unit 15, a print control unit 107 which controls the respective control units 101 to 106, and an input section 108 in which an operator inputs various information, as shown in FIG. 1.

Therefore, if an operator inputs print information by using the input section 108, the print control unit 107 controls the driving of the paper-supplying unit 11, the printer 12, the folding machine 13, the distributing unit 14, and the conveyance unit 15 through the respective control units 101 to 106.

When forming two types of signatures F (printed matter B) by using the printing device 10, an operator inputs print information for continuously creating, for example, 144-page printed matter B1 (the signature bundle G1/a bundle of nine signatures F1) and 112-page printed matter B2 (the signature bundle G2/a bundle of seven signatures F2) by using the input section 108. Then, the print control unit 107 controls the paper-supplying unit 11 through the paper-supplying control unit 101, thereby sending out a predetermined web W, controls the printer 12 through the printer control unit 102, thereby alternately printing the two types of printed matter B1 and B2, controls the folding machine 13 through the folding machine control unit 103, thereby forming the signatures F1 and F2, controls the distributing unit 14 through the distribution control unit 104, thereby distributing the signatures F1 and F2 which are sent in order, and separately discharges the signature bundles G1 and G2 by the conveyance unit 15 through the conveyance control units 105 and 106.

At this time, the print control unit 107 makes it possible to continuously discharge the signature bundles G1 and G2 having different numbers of signatures from the two conveyance lines L1 and L2 by controlling the driving of the distributing unit 14 through the distribution control unit 104 according to a print command.

That is, the print control unit 107 counts the signatures F formed by transversely cutting the web W in the folding machine 13 and switches an output destination of the folding machine 13 between the first conveyance line L1 and the second conveyance line L2 by the distributing unit 14 if the number of counts of the signatures F reaches a predetermined number of counts (nine counts or seven counts) set in advance. At this time, when the signatures F1 or the signatures F2 formed in the folding machine 13 are stacked on one of the first conveyance line L1 and the second conveyance line L2, the signature bundle G1 or the signature bundle G2 formed by stacking a predetermined number of signatures on the other of the first conveyance line L1 and the second conveyance line L2 is discharged.

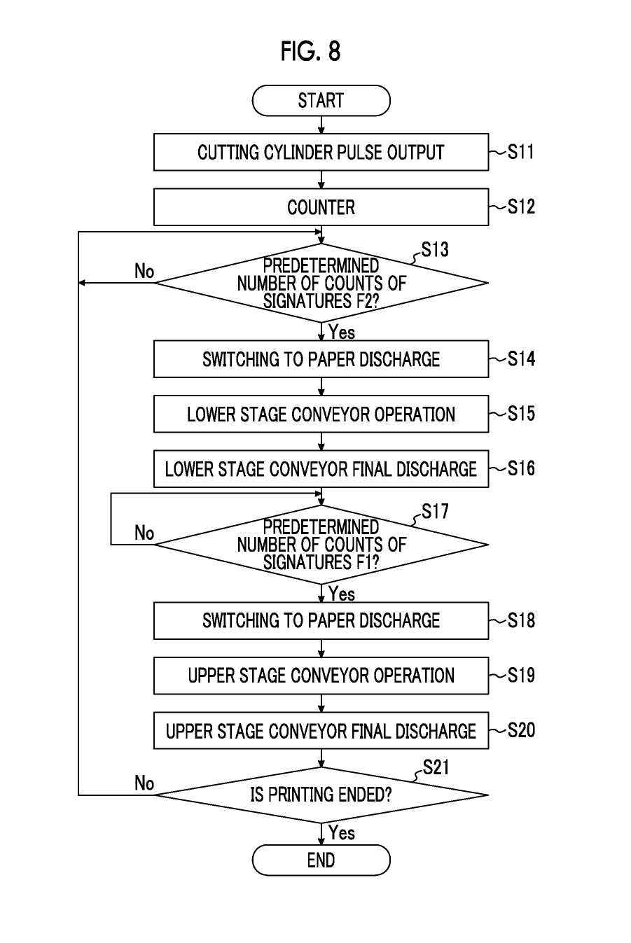

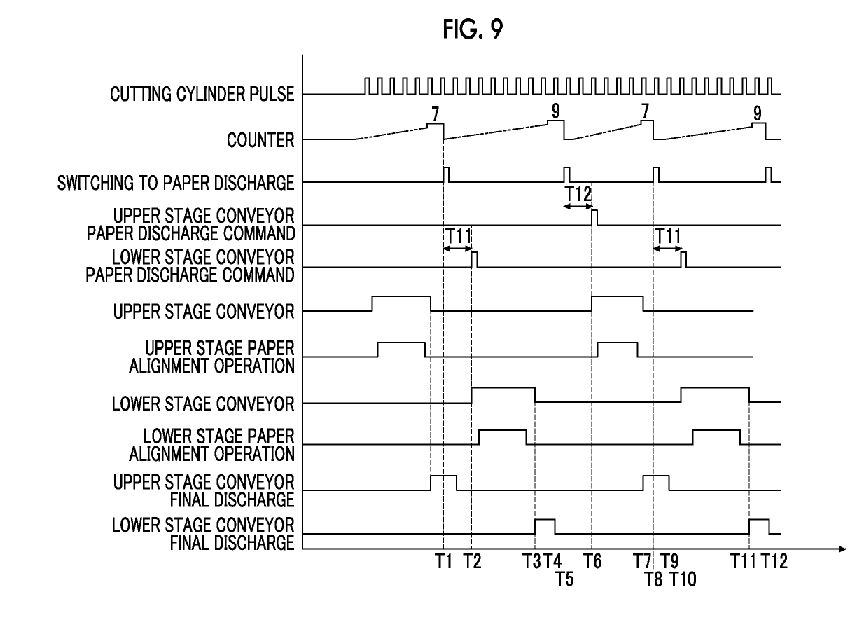

Here, a method of forming the two types of signature bundles G1 and G2 by using the printing device 10 will be specifically described by using a flowchart of FIG. 8 and a timing chart of FIG. 9.

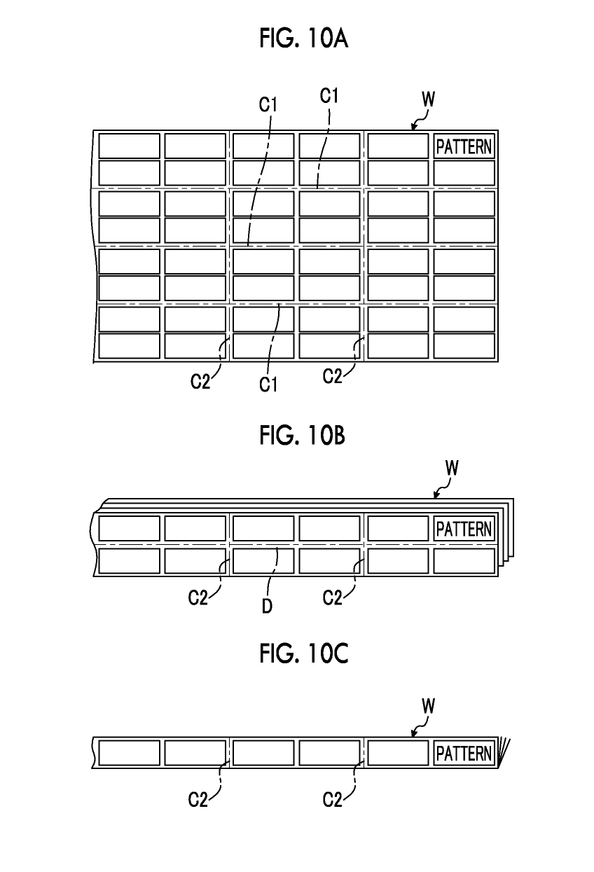

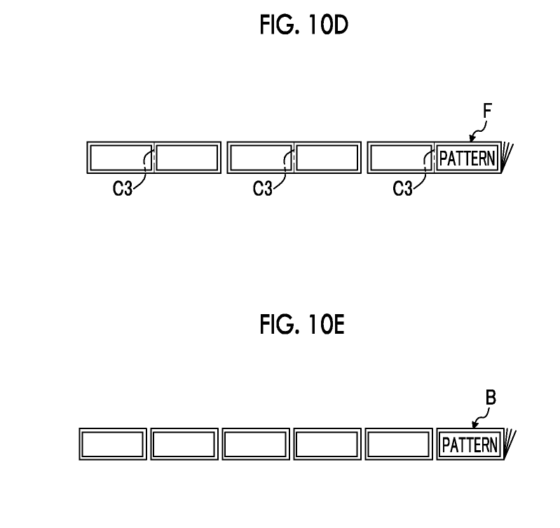

FIG. 8 is a flowchart showing a printing method using the printing device of this embodiment, FIG. 9 is a timing chart showing the printing method of this embodiment, FIG. 10A is a schematic diagram showing an imposition on the web, FIG. 10B is a schematic diagram showing the longitudinally cut and stacked webs, FIG. 10C is a schematic diagram showing the longitudinally folded webs, FIG. 10D is a schematic diagram showing the transversely cut signatures, and FIG. 10E is a schematic diagram showing the bound signatures.

The paper-supplying unit 11 sends out the web W, and the printer 12 alternately prints the two types of printed matter B1 and B2 (the signatures F1 and F2). That is, the 144-page printed matter B1 (the signature bundle G1/a bundle of nine signatures F1) and the 112-page printed matter B2 (the signature bundle G2/a bundle of seven signatures F2) are continuously created, and therefore, as shown in FIG. 10A, first, eight patterns arranged in the width direction of the web W are printed by nine rows in response to the printed matter B1, and subsequently, eight patterns arranged in the width direction of the web W are printed by seven rows in response to the printed matter B2. The printer 12 continuously performs alternately printing corresponding to the printed matter B1 and printing corresponding to the printed matter B2 by a predetermined number.

The folding machine 13 cuts the web W along the longitudinal direction in three cutting lines C1 by the slitter 31, thereby forming four webs W having the same width. Then, the turn bar 32 stacks the four webs W longitudinally cut by the slitter 31 one above the other, as shown in FIG. 10B, and then conveys the stacked webs. The triangular plate 33 longitudinally folds the four webs W stacked by the turn bar 32, along one longitudinal folding line D, as shown in FIG. 10C. The cutting unit 34 transversely cuts the four webs W longitudinally folded by the triangular plate 33, into a predetermined length, as shown in FIG. 10D, thereby forming the signatures F (F1 and F2).

If the signatures F1 or the signatures F2 which are sent from the folding machine 13 in order reach a predetermined number, the distributing unit 14 switches between the conveyance line L1 and the conveyance line L2. In the conveyance unit 15, the signatures F (F1 and F2) distributed by the distributing unit 14 are stacked on the respective conveyance lines L1 and L2 by a predetermined number, whereby the signature bundles G (G1 and G2) are formed, and different signature bundles G1 and G2 are respectively discharged from the respective conveyance lines L1 and L2.

In a distributing method by the distributing unit 14, as shown in FIG. 8, in step S11, the cutting cylinder 36 of the cutting unit 34 transversely cuts the four webs W into a predetermined length, thereby forming the signatures F2, and outputs one pulse each time it transversely cuts the webs W (every one rotation). In step S12, a counter counts the pulse, and in step S13, whether the number of counts has reached the number of counts (seven counts) corresponding to the number of signatures F2 (seven signatures) is determined, and if it is determined that the number of counts has not reached seven counts (No), waiting is performed here. Then, if it is determined that the number of counts has reached seven counts (Yes), in step S14, switching to paper discharge is performed, and thus a discharge destination is switched from the upper stage conveyor 53 (the conveyance line L1) to the lower stage conveyor 54 (the conveyance line L2) by the distributing unit 14.

Then, in step S15, the lower stage conveyor 54 is operated, and in step S16, the signature bundle G2 formed by stacking the seven signatures F2 is discharged by the lower stage conveyor 54.

Specifically, as shown in FIG. 9, at time T1, if the number of counts reaches seven counts, switching by the distributing unit 14 is performed, and thereafter, at time T2 when conveyance time T11 from the cutting unit 34 to the lower stage conveyor 54 has elapsed, the lower stage conveyor 54 is operated at a first conveyance speed. At this time, since the lower stage conveyor 54 is operated at a slow first conveyance speed, paper alignment of the seven signatures F2 stacked on the lower stage conveyor 54 is performed. Then, during the period from time T3 to time T4, the lower stage conveyor 54 is operated at a second conveyance speed faster than the first conveyance speed and discharges the signature bundle G2.

On the other hand, referring back to FIG. 8, in step S13, if the number of counts reaches the number of counts (seven counts) corresponding to the number of signatures F2 (seven signatures), the counter is reset and the counter counts the pulses from 0 again, and in step S17, whether the number of counts has reached the number of counts (nine counts) corresponding to the number of signatures F1 (nine signatures) is determined, and if it is determined that the number of counts has not reached nine counts (No), waiting is performed here. Then, if it is determined that the number of counts has reached nine counts (Yes), in step S18, switching to paper discharge is performed, and thus a discharge destination is switched from the lower stage conveyor 54 (the conveyance line L2) to the upper stage conveyor 53 (the conveyance line L1) by the distributing unit 14.

Then, in step S19, the upper stage conveyor 53 is operated, and in step S20, the signature bundle G1 formed by stacking the nine signatures F1 is discharged by the upper stage conveyor 53.

Specifically, as shown in FIG. 9, at time T5, if the number of counts reaches nine counts, switching by the distributing unit 14 is performed, and thereafter, at time T6 when conveyance time T12 from the cutting unit 34 to the upper stage conveyor 53 has elapsed, the upper stage conveyor 53 is operated at the first conveyance speed. At this time, since the upper stage conveyor 53 is operated at the slow first conveyance speed, paper alignment of the nine signatures F1 stacked on the upper stage conveyor 53 is performed. Then, during the period from time T7 to time T9, the upper stage conveyor 53 is operated at the second conveyance speed faster than the first conveyance speed and discharges the signature bundle G1.

Then, referring back to FIG. 8, in step S17, if the number of counts reaches the number of counts (nine counts) corresponding to the number of signatures F1 (nine signatures), the counter is reset and the counter counts the pulses from 0 again. In step S21, whether the printing of all the signature bundles G1 and G2 has ended is determined, and if the printing has not been ended, the routine returns to step S13. That is, in step S13, whether the number of counts has reached the number of counts (seven counts) corresponding to the number of signatures F2 (seven signatures) is determined.

In addition, as shown in FIG. 9, before the signature bundle G1 is discharged by the upper stage conveyor 53, at time T8, the number of counts reaches seven counts, and thus the switching by the distributing unit 14 is performed. However, at this time, since the lower stage conveyor 54 is vacant, it is possible to deal with work by operating the lower stage conveyor 54.

Incidentally, the printing/bookbinding system of this embodiment has a bookbinding device which is described below, in addition to the printing device 10 described above. The printing/bookbinding system changes specifications in the bookbinding device according to the type of the printed matter B (the signature bundle G) which is printed in the printing device 10. That is, the print control unit 107 is made so as to be able to output timing data in which the type of the signature bundle G is changed, to the bookbinding device. On the other hand, the bookbinding device is made so as to be able to change specifications in various units according to the timing data in which the type of the printed matter B (the signature bundle G) is changed, having output from the print control unit 107.

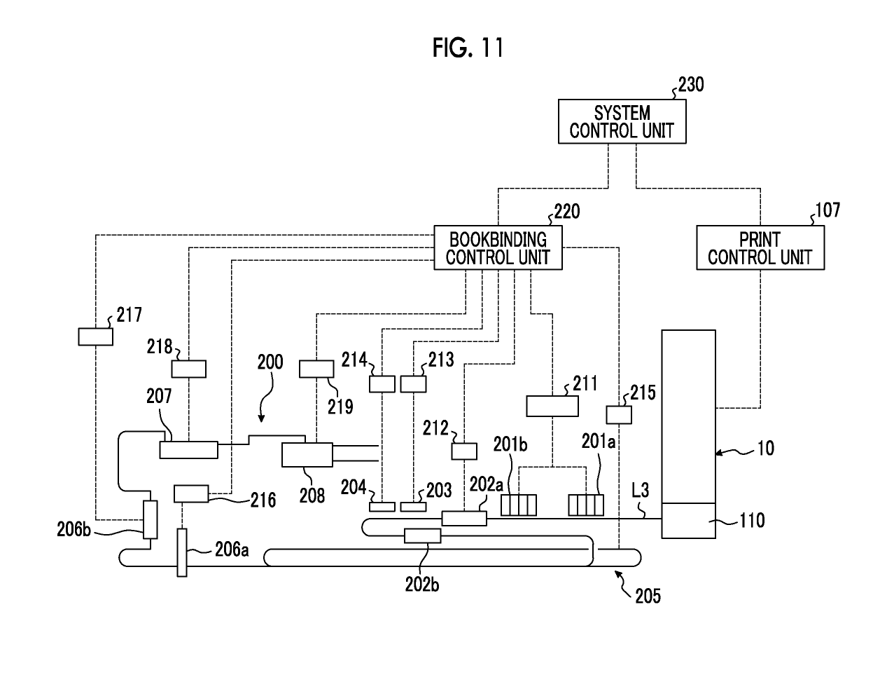

FIG. 11 is a schematic configuration diagram showing the printing/bookbinding system.

In the printing/bookbinding system of this embodiment, as shown in FIG. 11, a bookbinding device 200 has gathering units 201a and 201b, posture changing units 202a and 202b, a milling unit 203, a front cover attaching unit 204, a drying unit 205, cutting units 206a and 206b, a cover attaching unit 207, and a tying unit 208, and these units are disposed in order along a conveyance line L3. In addition, in the printing/bookbinding system of this embodiment, description is made as the gathering units being two. However, there is no limitation thereto, and the gathering unit may be one and may also be three or more.

The gathering units 201a and 201b are for inserting missing pages (signatures) into the signatures F printed in the printing device 10, thereby arranging the signatures into a final signature form. The signatures F discharged from the printing device 10 are conveyed in a state where sheets are stacked one above the other and lie down sideways. The posture changing units 202a and 202b are for changing the posture of the signatures F which are conveyed along the conveyance line L3 and are in a state of lying down sideways, to a state of being upright with the back side (the closed side) down, and returning the posture of the signatures F in the upright state, to a state of lying down sideways.

The milling unit 203 is for cutting off the back side by a predetermined amount by a cutter with respect to the signatures F with the posture changed to a state of being upright with the back side down by the posture changing unit 202a, and then applying glue to the cut-off back side. The front cover attaching unit 204 is for covering the signatures F in the upright state with a front cover (an inside cover) from outside, thereby bonding the front cover to the back side of the signatures F cut off and applied with glue. In addition, the signatures F with the front cover bonded thereto by the front cover attaching unit 204 are returned to a state of lying down sideways by the posture changing unit 202b.

The drying unit 205 is for circulating and conveying the signatures F in a portion of the conveyance line L3, thereby performing natural drying. The signature F printed in the printing device 10 has the bindings B which are longitudinally continuous, as shown in FIG. 10D, and therefore, the cutting unit 206a transversely cuts the signature F in a cutting line C3, whereby the bindings B are formed, as shown in FIG. 10E. Further, the cutting unit 206b is for trimming end faces by cutting three sides except for the back side (the closed side) in three directions by a cutter in a state where the binding B is pressed and positioned by a pressing member. In addition, the cutting unit 206b sometimes cuts two sides except for the back side (the closed side) and the upper side in two directions by a cutter.

The cover attaching unit 207 is for making the binding B be in an upright state where the back side is down and attaching a cover (an outside cover) and a band from outside. At this time, a bookmark or the like is inserted into the binding B. The tying unit 208 is for bundling and discharging a plurality of bindings B.

The bookbinding device 200 of this embodiment configured in this manner is provided with a collation control unit 211 which controls the driving of the gathering units 201a and 201b, a posture change control unit 212 which controls the driving of the posture changing units 202a and 202b, a milling control unit 213 which controls the driving of the milling unit 203, a front cover attachment control unit 214 which controls the driving of the front cover attaching unit 204, a drying control unit 215 which controls the driving of the drying unit 205, a first cutting control unit 216 which controls the driving of the cutting unit 206a, a second cutting control unit 217 which controls the driving of the cutting unit 206b, a cover attachment control unit 218 which controls the driving of the cover attaching unit 207, a tying control unit 219 which controls the driving of the tying unit 208, and a bookbinding control unit 220 which controls the respective control units 211 to 216.

Then, the print control unit 107 and the bookbinding control unit 220 are connected to a system control unit 230 and various commands are input thereto. That is, the system control unit 230 receives various print information which is input from the print control unit 107, and outputs a bookbinding command to the bookbinding control unit 220 based on the print information.

In this embodiment, the printing device 10 can continuously form different types of signatures F1 and F2 and discharge different types of signature bundles G1 and G2, and therefore, the bookbinding device 200 can receive the different types of signature bundles G1 and G2 formed in the printing device 10 and continuously bind different types of printed matter B1 and B2.

For this reason, the system control unit 230 receives timing data in which the type of the signature bundle G (G1 or G2) is changed, which is output from the print control unit 107, and data relating to the type of the signature bundle G (G1 or G2), and outputs a command changing the specifications of various units based on the respective data, to the bookbinding control unit 220.

In this case, if the forms of the signature bundles G (G1 and G2) printed in the printing device 10 are different from each other, the bookbinding device 200 is required to change the specifications of various units.

That is, in the gathering units 201a and 201b, since the signatures F are different from each other, it is necessary to change the type or the amount of the printed matter which is collated. In the posture changing units 202a and 202b, since the sizes or the thicknesses of the signatures F which are supported are different from each other, it is necessary to change the position of a guide which supports the signatures F. In the milling unit 203, since the sizes or the thicknesses of the signatures F which are treated are different from each other, it is necessary to change the position of the cutter or the amount of glue. In the front cover attaching unit 204, since the signatures F are different from each other, it is necessary to change the type of the front cover (the inside cover). In the drying unit 205, since the amount of glue applied to the signatures F is different, it is necessary to change drying time. In the cutting units 206a and 206b, since the sizes or the thicknesses of the signatures F which are treated are different from each other, it is necessary to change the position of the pressing member or the cutter. In the cover attaching unit 207, since the signatures F are different from each other, it is necessary to change the type of the cover or the band. In the tying unit 208, since the sizes or the thicknesses of the signatures F which are treated are different from each other, it is necessary to change a tying position.

The respective control units 211 to 219 control the respective units based on the respective data from the bookbinding control unit 220 and change the specifications in accordance with the forms of the signature bundles G (G1 and G2) which are changed.

In addition, in the printing device 10, different types of signature bundles G1 and G2 are alternately discharged, and for example, while the signature bundles G1 which are discharged are sent to the bookbinding device 200 in order, the signature bundles G2 are stored in a storage section 110. Then, if the signature bundles G2 are stored in the storage section 110 by a predetermined number, now, while the signature bundle G2 stored in the storage section 110 and the signature bundle G2 which is discharged from the printing device 10 are sent to the bookbinding device 200 in order, the signature bundles G1 are stored in the storage section 110.

In this manner, the printing device of this embodiment is provided with the paper-supplying unit 11 which supplies the web W from the rolled paper, the printer 12 which can continuously print different images on the web W, the folding machine 13 which forms the signatures F by longitudinally cutting and stacking the printed webs W and then longitudinally folding and transversely cutting the webs, the conveyance unit 15 having the plurality of conveyance lines L1 and L2 for conveying the signatures F with the signatures F stacked by a predetermined number, the distributing unit 14 which distributes the signatures F to any one of the plurality of conveyance lines L1 and L2, and the print control unit 107 which makes it possible to continuously discharge the signature bundles G1 and G2 having different numbers of signatures from the plurality of conveyance lines L1 and L2 by operating the distributing unit 14 according to a print command.

Therefore, the print control unit 107 operates the distributing unit 14 according to a print command, and therefore, different types of signatures F1 and F2 formed in the folding machine 13 are respectively distributed to the plurality of conveyance lines L1 and L2 by a necessary number, and thus it is possible to stack different numbers of signatures F1 and F2 on the respective conveyance lines L1 and L2 and continuously discharge the signatures F1 and F2 as different types of signature bundles G1 and G2 from the respective conveyance lines L1 and L2 without stopping the printing device 10, whereby it is possible to improve the productivity of a printing job.

In the printing device of this embodiment, the print control unit 107 counts the signatures F1 or the signatures F2 formed by transversely cutting the webs W in the folding machine 13 and switches an output destination of the folding machine 13 between the first conveyance line L1 and the second conveyance line L2 by the distributing unit 14 if the number of counts of the signatures F1 or the signatures F2 reaches a predetermined number of counts set in advance. Therefore, it is possible to continuously perform a printing job without stopping the paper-supplying unit 11, the printer 12, and the folding machine 13.

In the printing device of this embodiment, when the signatures F1 formed in the folding machine 13 are stacked on the first conveyance line L1, the signature bundle G2 with the signatures F2 stacked on the second conveyance line L2 by a predetermined number is discharged. Therefore, while the signatures F1 are stacked on the first conveyance line L1, the second conveyance line L2 discharges the signature bundle G2, and therefore, stacking work and discharge work of the signatures F are alternately performed in the respective conveyance lines L1 and L2, whereby it is possible to continuously perform a printing job without stopping various units.

In the printing device of this embodiment, the folding machine 13 has the cutting unit 34 which transversely cuts the longitudinally cut and stacked webs W, and the print control unit 107 makes it possible to change a cutting timing by the cutting unit 34 according to a print command. Therefore, a timing of cutting the webs W is changed according to a print command, whereby it is possible to form the signatures F having different lengths without stopping a printing job.

In the printing device of this embodiment, the conveyance unit 15 is provided with the stacking cylinder 60 which stacks the signatures F1 and F2 discharged from the respective conveyance lines L1 and L2. Therefore, the plurality of signatures F1 and F2 which are discharged in the plurality of conveyance lines L1 and L2 are stacked by the stacking cylinder 60, whereby it is possible to efficiently form the signatures F having a large number of pages.

In the printing device of this embodiment, as the printer, an ink jet printer is applied. Therefore, it is possible to enable simplification and cost reduction of the device.

In the printing device of this embodiment, the print control unit 107 is made so as to be able to output timing data in which the types of the signatures F1 and F2 are changed to the bookbinding device 200. Therefore, the timing data in which the types of the signatures F1 and F2 are changed is output from the printing device 10 to the bookbinding device 200, whereby the printed matter B1 and B2 which are formed from the signatures F1 and F2 can be continuously treated in the bookbinding device 200.

Further, the bookbinding device of this embodiment is provided with the gathering units 201a and 201b, the posture changing units 202a and 202b, the milling unit 203, the front cover attaching unit 204, the drying unit 205, the cutting units 206a and 206b, the cover attaching unit 207, the tying unit 208, and the bookbinding control unit 220 which changes specifications in the respective units according to timing data in which the types of the printed matter B1 and B2 (the signature bundles G1 and G2) are changed, having output from the printing device 10.

Therefore, the specifications of various units are changed according to the timing data in which the types of the printed matter B1 and B2 (the signature bundles G1 and G2) are changed, and therefore, it is possible to continuously bind the printed matter B1 and B2 having different numbers of signatures without stopping the device, whereby it is possible to improve the productivity of a printing job.

Further, the printing/bookbinding system of this embodiment is provided with the printing device 10 which can distribute the signatures F to the plurality of conveyance lines L1 and L2, thereby discharging the signature bundles G1 and G2 having different numbers of signatures, the bookbinding device 200 which binds the printed matter B1 and B2 (the signature bundles G1 and G2), and the system control unit 230 which changes specifications in the bookbinding device 200 according to the types of the printed matter B1 and B2 which are printed in the printing device 10.

Therefore, the exchange of data relating to the types of the printed matter B1 and B2 (the signature bundles G1 and G2) is performed between the printing device 10 and the bookbinding device 200, whereby it is possible to continuously print and bind different types of printed matter B1 and B2.

In addition, in the embodiment described above, the printing/bookbinding system having the printing device 10 and the bookbinding device 200 has been described as continuously creating the 144-page printed matter B1 (the signature bundle G1/a bundle of nine signatures F1) and the 112-page printed matter B2 (the signature bundle G2/a bundles of seven signatures F2). However, the printing/bookbinding system is not limited to creating the printed matter B of these forms. For example, it is also possible to create a plurality of printed matter of the same type. Further, it is also possible to sequentially switch and create printed matter having different numbers of pages. For example, it is also possible to sequentially print printed matter having different numbers of pages, such as performing switching after the printing of the 144-page printed matter B1 and then printing the 112-page printed matter B2, thereafter, performing switching and then printing 116-page printed matter B3, and thereafter performing switching and then printing 96-page printed matter B4.

Further, in the embodiment described above, the printer 12 is configured so as to continuously perform alternately the printing corresponding to the printed matter B1 and the printing corresponding to the printed matter B2 by a predetermined number. However, a configuration may be made such that the same type of printed matter is discharged from the respective conveyance lines L1 and L2 by continuously performing the printing corresponding to the printed matter B1 or continuously performing the printing corresponding to the printed matter B2.

Further, in the embodiment described above, the system control unit 230 is configured so as to receive a variety of print information which is input from the print control unit 107 and output a bookbinding command to the bookbinding control unit 220 based on the print information. However, there is no limitation to this configuration. A configuration may be made so as to produce printed matter based on the instructions of, for example, a JDF (Job Definition Format) form. In this case, a configuration may be made such that various print data having timing data in which the types of the signatures F1 and F2 are changed is recorded in instructions and a variety of work is managed by the instructions.

Further, in the embodiment described above, the paper alignment of the signatures F stacked on the lower conveyor 54 and the upper conveyor 53 is performed. However, a paper alignment unit may be provided downstream of each of the lower conveyor 54 and the upper conveyor 53, rather than the paper alignment of the signatures F being performed in the lower conveyor 54 and the upper conveyor 53.
11: paper-supplying unit
12: printer
13: folding machine
14: distributing unit
15: conveyance unit
101: paper-supplying control unit
102: printer control unit
103: folding machine control unit
104: distribution control unit
105: first conveyance control unit
106: second conveyance control unit
107: print control unit (print controller)
108: input section
200: bookbinding device
201a, 201b: gathering unit
202a, 202b: posture changing unit
203: milling unit
204: front cover attaching unit
205: drying unit
206a, 206b: cutting unit
207: cover attaching unit
208: tying unit
211: collation control unit
212: posture change control unit
213: milling control unit
214: front cover attachment control unit
215: drying control unit
216: first cutting control unit
217: second cutting control unit
218: cover attachment control unit
219: tying control unit
220: bookbinding control unit (bookbinding controller)
230: system control unit (printing/bookbinding controller)
L1, L2, L3: conveyance line
W: web
F, F1, F2: signature
G, G1, G2: signature bundle
B, B1, B2: printed matter

1. A printing device comprising:
a paper-supplying unit that supplies a web from rolled paper;
a digital printer capable of continuously printing different images on the web sent out from the paper-supplying unit;
a folding machine that forms signatures by stacking, folding, and then transversely cutting the webs printed by the digital printer;
a conveyance unit having a plurality conveyance lines for conveying the signatures formed by the folding machine with the signatures stacked by a predetermined number;
a distributing unit that distributes the signatures formed by the folding machine to any one of the plurality of conveyance lines; and
a print controller that allows different numbers of signatures to be continuously discharged from the plurality of conveyance lines by distributing the signatures formed by the folding machine according to print information of printed matter that is printed to the plurality of conveyance lines by controlling an operation of the distributing unit.

2. The printing device according to claim 1, wherein the plurality of conveyance lines has a first conveyance line and a second conveyance line, and the print controller counts the signatures formed by transversely cutting the webs in the folding machine and switches an output destination of the folding machine between the first conveyance line and the second conveyance line by the distributing unit if the number of counts of the signatures reaches a predetermined number of counts set in advance.

3. The printing device according to claim 2, wherein during the signatures formed in the folding machine are stacked on the first conveyance line, the signatures stacked on the second conveyance line by a predetermined number are discharged.

4. The printing device according to claim 1, wherein the folding machine has a cutting unit that transversely cuts the longitudinally slit and stacked webs, and the print controller makes it possible to change a cutting timing by the cutting unit according to a print command.

5. The printing device according to claim 1, wherein the conveyance unit has a stacking unit that stacks a plurality of signatures discharged from the plurality of conveyance lines.

6. The printing device according to claim 1, wherein the digital printer has one or more ink jet printers.

7. The printing device according to claim 1, wherein the print controller can output timing data or informations in which the type of the signature is changed, to a bookbinding device.

8. A bookbinding device comprising:
a milling unit that cuts off a back side in printed matter by a predetermined amount and then applies glue;
a front cover attaching unit that bonds a front cover to the outside of the printed matter;
a drying unit that circulates the printed matter, thereby drying the glue;
a cutting unit that cuts an outer peripheral side of the printed matter; and
a bookbinding controller that changes specifications in the milling unit, the front cover attaching unit, the drying unit, and the cutting unit according to timing data in which the type of the printed matter is changed, having output from a printing device.

9. A printing/bookbinding system comprising:
a printing device that can continuously print different images on a web by a digital printer, form signatures by longitudinally slitting and stacking printed webs and then longitudinally folding and transversely cutting the webs, and distribute the signatures to a plurality of conveyance lines, thereby discharging printed matter having a different number of signatures for each of the conveyance lines;
a bookbinding device that cuts off a back side in the printed matter by a predetermined amount and then applies glue, bonds a front cover to the outside of the printed matter, performs drying, and then cuts an outer peripheral side of the printed matter; and
a printing/bookbinding controller that changes specifications in the bookbinding device according to print information of the printed matter which is printed in the printing device.
